(19) United States
(12) Patent Application Publication
(10) Pub. No.: US 2009/0207766 A1
(43) Pub. Date: Aug. 20, 2009

(54) WIRELESS NETWORK CONNECTION MANAGEMENT SYSTEM AND METHOD THEREOF

(75) Inventors: Wei-Chung Hwang, Hsinchu City (TW); Shin-Yan Chiou, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/111,158

(22) Filed: Apr. 28, 2008

(30) Foreign Application Priority Data
Feb. 20, 2008 (TW) 97105929

(51) Int. Cl. H04B 7/14

(52) U.S. Cl. 370/310

(57) ABSTRACT

Provided are a wireless network management system and a method thereof based on a positioning system. By the positioning system, whether there are available wireless access points (WAPs, or APs) at the vicinity of a communication device is identified, so the communication device needn't hold the search for the APs and the power thereof is saved. Besides, by path programming, the possible path of the communication device is known and the next available AP for wireless communication is identified, so the communication to the current AP can be quickly switched to the next AP if necessary. Furthermore, by positioning system, in case of path unknown, the communication device identifies available APs nearby, and when the communication device is moving, the communication device can quickly judges whether to switch the communication to a next available AP or not, based on identification of available APs

### CROSS-REFERENCE TO RELATED APPLICATION

This application claims the priority benefit of Taiwan application serial no. 97105929, filed on Feb. 20, 2008. The entirety of the above-mentioned patent application is hereby incorporated by reference herein and made a part of specification.

### BACKGROUND OF THE INVENTION

1. Field of the Invention

The present invention relates to a network connection management system.

2. Description of Related Art

Wireless devices have been broadly applied along with the development of information technology. Presently, wireless network access through wireless access points (WAPs or APs) is one of the most popular wireless applications.

An AP allows a wireless device to connect to a wireless network. In addition, an AP may also be served as an intermediary point for the connection and communication between a wire device and a wireless device.

However, a wireless device has to search for APs constantly so as to notify a user about all the available APs in the vicinity thereof. The wireless device consumes power unnecessarily if there is no AP in the vicinity thereof or all the APs in the vicinity thereof are private.

In addition, the optimal acceptance range of an AP is usually between 30 and 90 meters. A wireless device will be disconnected from a current AP providing service once the wireless device moves out of the acceptance range thereof. In this case, the wireless device has to be connected to another AP if network services are still required. So, following actions are taken: the wireless device disconnecting from the current AP, the wireless device searching for APs, a user browsing the APs, the user determining whether there is any available AP, the user commanding the wireless device to connect to one available AP, the user inputting a password (if necessary), executing authentication between the wireless device and the AP, and connecting the wireless device to the AP.

The global positioning system (GPS) can provide precise position information, speed information, and time information to users at most areas around the globe and it allows a user at anywhere around the world or in the near-earth space to determine its precise 3-D location, 3-D movement, and time.

The GPS system has following advantages: available around the clock and in all weathers; global coverage up to 98%; highly precise in 3-D location and 3-D movement; high operation speed, timesaving, efficient; broad application, and multi-function; mobile positioning; and highly private because a GPS receiver needs not to issue any signal during its operation.

Taiwan patent No. I286284, entitled “advertising system and method based on personal profile integrated with GPS position” discloses that a customized advertisement is broadcasted to different users by the GPS system and custom profiles.

The present invention provides a wireless network connection management system and a method thereof, wherein a communication device is positioned by a positioning system so that available APs in the vicinity of the communication device can be detected and the communication device can be wirelessly and conveniently connected to the network through an available AP.

### SUMMARY OF THE INVENTION

Accordingly, one aspect of the present invention is directed to a wireless network connection management system and a method thereof, wherein whether there is any available wireless access point (WAP or AP) in the vicinity of a communication device can be determined by positioning the communication device with a positioning system.

Another aspect of the present invention is directed to a wireless network connection management system and a method thereof, wherein a possible moving path of a communication device can be determined through path planning of a positioning system, so that a next available AP can be obtained.

Still another aspect of The present invention is directed to a wireless network connection management system and a method thereof, wherein all the APs in the vicinity of a communication device can be detected by positioning the communication device via a positioning system, so that whether the AP to which the communication device is connected is to be switched can be quickly determined when the communication device moves.

One example of the present invention provides a wireless network connection management method for a static communication device, wherein the wireless network connection management method is suitable for a wireless network connection management system including a positioning system, the communication device, and a plurality of APs. The wireless network connection management method includes: positioning the static communication device by the positioning system; obtaining a position information and a coverage information of the APs by the communication device; determining whether there is at least one AP available to the communication device according to the position information and the coverage information; and wirelessly connecting the communication device to the available AP.

Another example of the present invention provides a wireless network connection management method for a dynamic communication device moving along a known path, wherein the wireless network connection management method is suitable for a wireless network connection management system including a positioning system, the communication device, and a plurality of APs. The wireless network connection management method includes: positioning the communication device which is already in or is going to be in a dynamic state by the positioning system; obtaining a position information and a coverage information of the APs by the communication device; planning a path information of the communication device according to a current position and a destination of the communication device; searching for APs available to the communication device among the APs according to the path information, the position information, and the coverage information; determining a AP switch position; wirelessly connecting the communication device to an available AP among the APs; and allowing the communication device to be wirelessly and automatically connected to another available AP among the APs when the communication device moves close to the AP switch position.

Still another example of the present invention provides a wireless network connection management method for a dynamic communication device moving along an unknown path, wherein the wireless network connection management method is suitable for a wireless network connection management system including a positioning system, the communication device, and a plurality of APs. The wireless network connection management method includes: positioning the communication device by the positioning system; obtaining a position information and a coverage information of the APs by the communication device; searching for all the APs available to the communication device among the APs according to the position information and the coverage information; wirelessly connecting the communication device to an available AP among the APs; determining whether the communication device is moving; predicting a next available AP if the communication device is moving; and wirelessly and automatically connecting the communication device to the predicted next available AP when the communication device moves out of a coverage of the currently connected AP.

Yet another example of the present invention provides a wireless network connection management system including a communication device, a positioning system for positioning the communication device, and a plurality of APs. The communication device wirelessly accesses a network through the APs and obtains a position information and a coverage information of the APs. When the communication device is in a static state, the communication device determines whether there is at least one available AP according to the position information and the coverage information; and the communication device is wirelessly connected to the available AP. When the communication device is already in or is going to be in a dynamic state moving along a known path, the communication device plans a path information according to a current position and a destination thereof; the communication device searches for available APs among the APs according to the path information, the position information, and the coverage information; the communication device determines an AP switch position; the communication device is wirelessly connected to an available AP among the APs; and the communication device is wirelessly and automatically connected to another available AP among the APs if the communication device moves to the AP switch position. When the communication device is already in or is going to be in a dynamic state moving along an unknown path, the communication device is wirelessly connected to an available AP among the APs; whether the communication device is moving is determined; the communication device predicts a next available AP if the communication device is moving; and the communication device is wirelessly and automatically connected to the predicted next available AP if the communication device moves out of a coverage of the currently connected AP.

In summary, according to examples of the present invention, a communication device is positioned by a positioning system so that the communication device needs not to search for APs constantly and accordingly the power consumption thereof is reduced. Moreover, through the wireless network connection management system, the communication device is allowed to wirelessly, automatically, and seamlessly access a network regardless of whether the communication device is in a static state, in a dynamic state moving along a known path, or in the dynamic state moving along an unknown path.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of a wireless network connection management system according to a first embodiment of the present invention, wherein a communication device is in a static state.

FIG. 1B is a flowchart illustrating how the static communication device in the wireless network connection management system illustrated in FIG. 1A searches for wireless access points (WAPs or APs).

FIG. 2A is a diagram of a wireless network connection management system according to a second embodiment of the present invention, wherein a communication device is in a dynamic state and the moving path thereof is already planned.

FIG. 2B is a flowchart illustrating how the dynamic communication device, moving along the known path, in the wireless network connection management system illustrated in FIG. 2A searches for APs.

FIG. 3A is a diagram of a wireless network connection management system according to a third embodiment of the present invention, wherein a communication device is in a dynamic state and the moving path thereof is unknown.

FIG. 3B is a flowchart illustrating how the dynamic communication device, moving along unknown path, in the wireless network connection management system illustrated in FIG. 3A searches for APs.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

### Wireless Network Access by a Static Communication Device

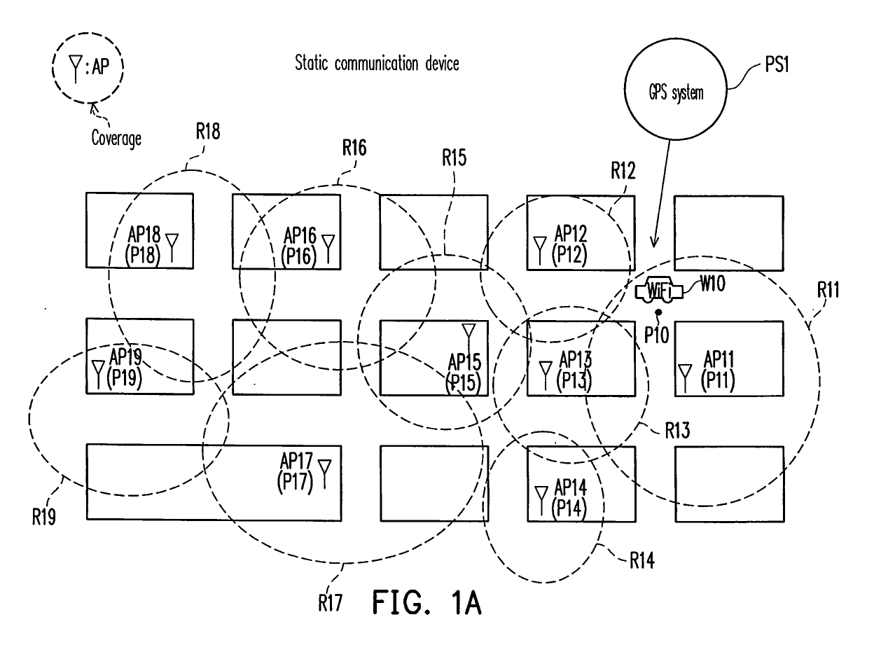

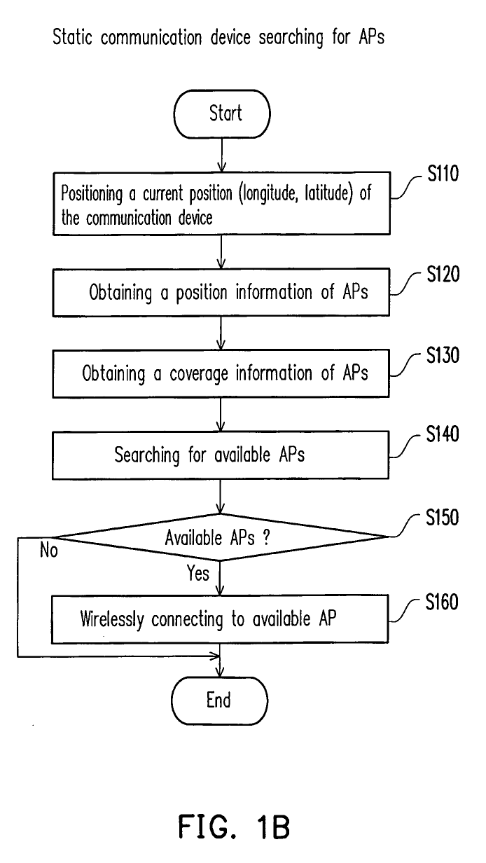

FIG. 1A is a diagram of a wireless network connection management system according to the first embodiment of the present invention, wherein the communication device is in a static state. Referring to FIG. 1A, the wireless network connection management system includes a communication device W10, a positioning system PSI, and a plurality of wireless access points (WAPs or APs). The communication device W10 may be a WiFi communication device, and the positioning system PSi may be a GPS system. However, the present invention is not limited thereto.

FIG. 1A illustrates nine APs AP11˜AP19, wherein these APs AP11˜AP19 are respectively positioned at positions P11˜P19 and have respective coverage areas R11˜R19. Number, positions, and coverage area of the APs are not intended for limiting the present invention.

First, an AP profile is stored in the communication device W10. The AP profile provides a position information and a coverage information of the AP. The position information of the APs indicates the position of each AP. As shown in FIG. 1A, the positions of the APs AP11˜AP19 are respectively P11˜P19. The coverage information of the APs indicates the area covered by each AP. As shown in FIG. 1A, the coverage of the APs AP11˜AP19 are respectively R11˜R19.

Alternatively, in the present embodiment, an AP position profile and an AP coverage profile, rather than the AP profile, may be stored into the communication device W10. The AP position profile provides the position information of the APs, namely, the AP position profile indicates that the APs AP11˜AP19 are respectively positioned at the positions P11˜P19. The AP coverage profile provides the coverage information of the APs, namely, the AP coverage profile indicates that the APs AP11˜AP19 respectively cover the areas R11˜R19.

Referring to FIG. 1A again, when the communication device W10 is in a static state, the communication device W10 is positioned by a GPS system, so as to obtain a current position P10 (i.e. the longitude and latitude of the position P10) of the communication device W10. Next, the communication device W10 obtains the position information of APs around the position P10 (i.e. the positions P11˜P19 of the APs AP11˜AP19) according to the AP profile or the AP position profile. Besides, the communication device W10 also obtains the coverage information of the APs around the position P10 (i.e. the coverage R11˜R19 of the APs AP11˜AP19) according to the AP profile or the AP coverage profile.

Thereafter, the communication device W10 determines whether there is any available AP around the position P10 according to the position information and the coverage information. This can be done by determining whether the current position P10 of the communication device W10 is within the coverage of any AP. An AP is considered as an available AP to which the communication device W10 can be connected if the communication device W10 is positioned within the coverage of the AP. As shown in FIG. 1A, the communication device W10 finds an available AP AP11 around the position P10. The communication device W10 is wirelessly connected to AP11 in order to access network through AP11. The communication device W10 is disconnected from AP11 when it needs not to access network.

It should be noted that the communication device can be directly connected to an available AP if no password authentication is required. Contrarily, if password authentication is required, an authentication password profile can be stored into the communication device in advance, and the authentication between the communication device and the AP can be then carried out according to the authentication password profile. The communication device can be wirelessly connected to the AP if it passes the authentication.

FIG. 1B is a flowchart illustrating a wireless network connection management method according to the first embodiment of the present invention. As shown in FIG. 1B, the wireless network connection management method includes following steps. In step S10, the communication device is positioned, namely, the longitude and latitude of the communication device are obtained, by the positioning system. In step S120, the communication device obtains the position information of the APs in the vicinity thereof according to the AP profile or the AP position profile. In step S130, the communication device obtains the coverage information of the APs in the vicinity thereof according to the AP profile or the AP coverage profile. In step S140, the communication device searches for available APs according to the position information and the coverage information. In step S150, the communication device determines that whether there is any available AP. The process proceeds to step S160 if there is available AP, and the process is ended if there is no available AP. In step S160, the communication device is wirelessly connected to an available AP so as to access network through the available AP.

According to the first embodiment of the present invention, the communication device is positioned by the positioning system without any modification to the wireless network connection system and the positioning system. Thereby, the communication device can find available APs without efforts of searching for APs constantly, and accordingly the power consumption of the communication device can be reduced.

### Second Embodiment

### Wireless Network Access of a Dynamic Communication Device with a Known Path

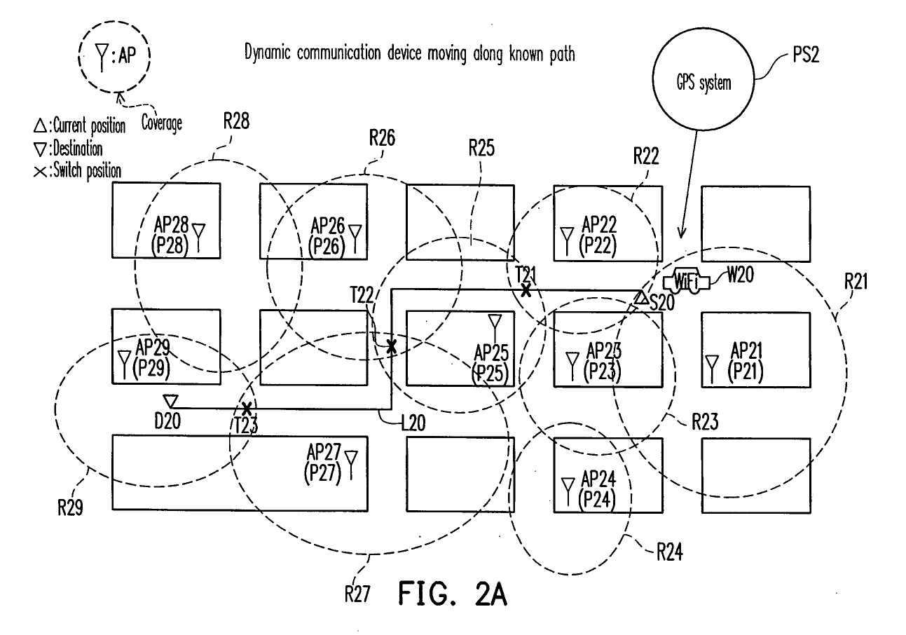

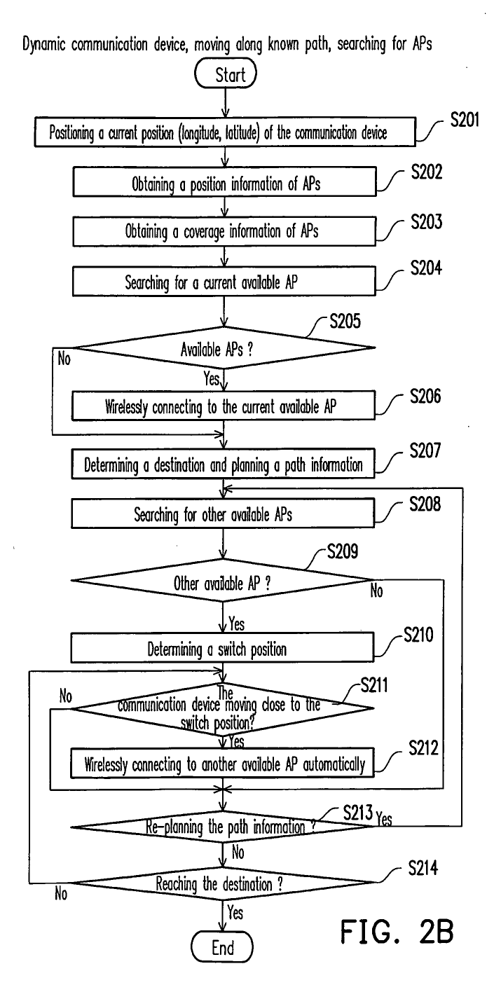

FIG. 2A is a diagram of a wireless network connection management system according to the second embodiment of the present invention, wherein the communication device is in a dynamic state and the moving path thereof is already planned. Referring to FIG. 2A, the wireless network connection management system includes a communication device W20, a positioning system PS2, and a plurality of APs. The communication device W20 may be a WiFi communication device, and the positioning system PS2 may be a GPS system. However, the present invention is not limited thereto.

As shown in FIG. 2A, nine APs AP21˜AP29 are respectively positioned at positions P21˜P29 and have respective coverage areas R21˜R29. Number, positions, and coverage of the APs are not intended for limiting the present invention.

First, an AP profile is stored in the communication device W20. The AP profile provides a position information and a coverage information of the APs. The position information of the APs indicates the position of each AP. As shown in FIG. 2A, the positions of the APs AP21˜AP29 are respectively P21˜P29. The coverage information of the APs indicates the area covered by each AP. As shown in FIG. 2A, the coverage of the APs AP21˜AP29 is respectively R21˜R29.

Alternatively, in the present embodiment, an AP position profile and an AP coverage profile may be stored in the communication device W20. The AP position profile provides the position information of the APs, namely, the AP position profile indicates that the APs AP21˜AP29 are respectively positioned at the positions P21˜P29. The AP coverage profile provides the coverage information of the APs, namely, the AP coverage profile indicates that the APs AP21˜AP29 respectively cover the areas R21˜R29.

Referring to FIG. 2A, when the communication device W20 is in a dynamic state and the moving path thereof is already known, the communication device W20 is positioned by a GPS positioning system so as to obtain a current position S20 (i.e. the longitude and latitude of the position S20) thereof. Next, the communication device W20 obtains the position information of the APs around the position S20 (i.e. the positions P21˜P29 of the APs AP21˜AP29) according to the AP profile or the AP position profile. Besides, the communication device W20 also obtains the coverage information of the APs around the position S20 (i.e. the coverage R21˜R29 of the APs AP21˜AP29) according to the AP profile or the AP coverage profile.

Thereafter, a destination D20 is assigned to the communication device W20, and the communication device W20 plans a path information according to the current position S20 and the destination D20, as the path L20 shown in FIG. 2A. However, the path may also be set manually. The communication device W20 searches for available APs among the APs AP21˜AP29 which allow the communication device W20 to wirelessly access network when the communication device W20 moves along the path L20 according to the path information, the position information, and the coverage information. As shown in FIG. 2A, the APs AP22, AP25, AP27, and AP29 are found in sequence. Switch positions along the path L20 are also determined according to the path information, the position information, and the coverage information. For example, switch positions T21, T22, and T23 are sequentially determined along the path L20.

A switch position is set when the communication device moves along the path information and enters into the overlapped coverage of at least two APs. For example, referring to FIG. 2A, at first, the path L20 only passes through the coverage R22 of AP22, then the path L20 passes through the overlapped coverage of AP22 and AP25, and after that the path L20 passes through the coverage R25 of AP25. Accordingly, T21 can be set as the switch position. However, foregoing condition for determining a switch position is not intended for limiting the present invention.

The communication device W20 is wirelessly connected to an available AP (for example, AP22) when it is at the current position S20. While moving along the path L20, the communication device W20 moves within only the coverage R22 of AP22, namely, the communication device W20 wirelessly accesses network through AP22. When the communication device W20 moves into the overlapped coverage of AP22 and AP25, for example, when the communication device W20 moves to the switch position T21, the communication device W20 is disconnected from AP22 and is wirelessly connected to AP25 automatically and seamlessly, so as to access network through AP25.

The communication device W20 continues to move along the path L20. When the communication device W20 moves into the overlapped coverage of AP25 and AP27, namely, when the communication device W20 moves to the switch position T22, the communication device W20 is disconnected from AP 25 and is wirelessly connected to AP27 automatically and seamlessly, so as to access network through AP27.

The communication device W20 continues to move along the path L20. When the communication device W20 moves to the overlapped coverage of AP27 and AP29, namely, when the communication device W20 moves to the switch position T23, the communication device W20 is disconnected from AP27 and is wirelessly connected to AP29 automatically and seamlessly, so as to access network through AP29.

Finally, the communication device W20 moves to the destination D20 along the path L20. Since the destination D20 is within the coverage R29 of AP29, the communication device W20 wirelessly accesses the network through AP29 at the destination D20. If the communication device W20 needs not to access network anymore, it is disconnected from the currently connected AP, for example, the communication device W20 is disconnected from AP29.

It should be noted that if password authentication is not required, the communication device can be wirelessly connected to an available AP directly. If password authentication is required, an authentication password profile can be stored in advance in the communication device, and the authentication between the communication device and the AP can then be carried out according to the authentication password profile. The communication device can be wirelessly connected to an AP if the communication device passes the authentication of the AP.

Additionally, the communication device cannot access network if there is no available AP within a particular section of the path when the communication device moves along the path information. In this case, the communication device can be switched to the conventional AP searching mode, wherein the communication device W20 searches for APs constantly so as to obtain currently available APs in the vicinity thereof and wirelessly access network. The communication device stays in the conventional AP searching mode until it moves into the coverage of an available AP, and the communication device is then wirelessly connected to the available AP so as to access network through this AP.

FIG. 2B is a flowchart illustrating a wireless network connection management method according to the second embodiment of the present invention. As shown in FIG. 2B, the wireless network connection management method includes following steps. In step S201, the communication device is positioned, namely, the longitude and latitude of the communication device are obtained, by the positioning system. In step S202, the communication device obtains the position information of the APs in the vicinity thereof according to the AP profile or the AP position profile. In step S203, the communication device obtains the coverage information of the APs in the vicinity thereof according to the AP profile or the AP coverage profile. In step S204, the communication device searches for all the currently available APs according to the position information, the coverage information, and the current position thereof. In step S205, the communication device determines whether there is any available AP. If available APs are found, the process proceeds to step S206, otherwise the process proceeds to step S207. In step S206, the communication device is wirelessly connected to a currently available AP found in step S205. In step S207, a destination is set in the communication device, and the communication device plans a path information according to the destination and the current position thereof, and the communication device moves according to the path information. In step S208, the communication device searches for other available APs, namely, other available APs when the communication device moves along the path information, according to the path information, the position information, and the coverage information. In step S209, whether the communication device finds other available APs is determined. If other available APs are found, the process proceeds to step S210, otherwise the process proceeds to step S213. In step S210, the communication device determines a switch position on the moving path according to the path information, the position information, and the coverage information. In step S211, whether the communication device has moved close to the switch position is determined. If the communication device is moved close to the switch position, the process proceeds to step S212, otherwise the process proceeds to step S213. In step S212, the communication device is wirelessly connected to an available AP found in step S208 automatically and quickly. In step S213, whether the path information of the communication device is to be re-planned is determined. If so, the process proceeds to step S208, otherwise the process proceeds to step S214. In step S214, whether the communication device has moved to the destination of the path information is determined. If the communication device has moved to the destination, the process is ended, otherwise the process proceeds to step S211.

According to the second embodiment of the present invention, the communication device is positioned by the positioning system without modification to the wireless network connection system and the positioning system, so that the communication device can find available APs without search for APs constantly, and accordingly the power consumption of the communication device can be reduced. Moreover, the communication device can predict a next available AP by determining a switch position. Accordingly, the AP to which the communication device is connected can be switched automatically, quickly, and seamlessly so that the communication device can access network seamlessly and the time required for the AP switching can be greatly reduced.

### Third Embodiment

### Wireless Network Access of a Dynamic Communication Device with an Unknown Path

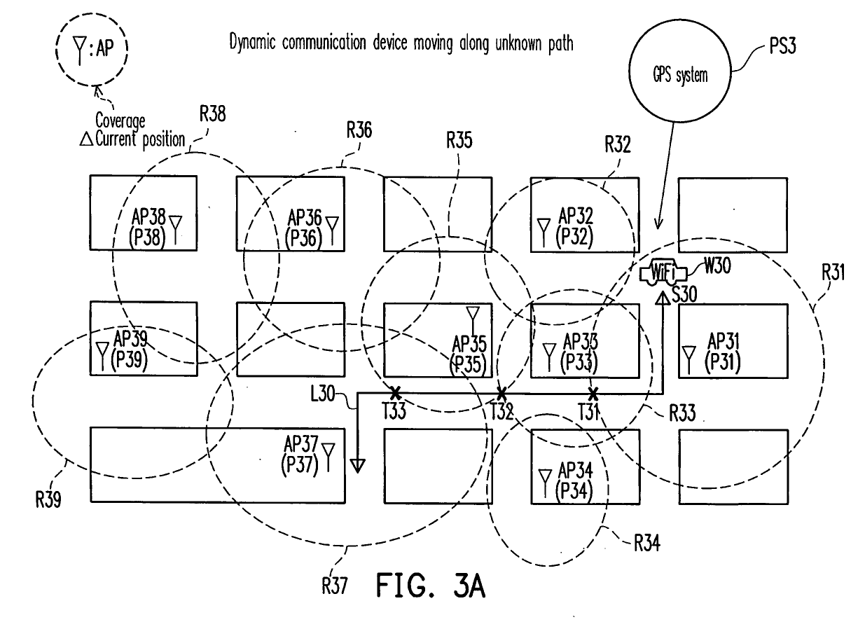

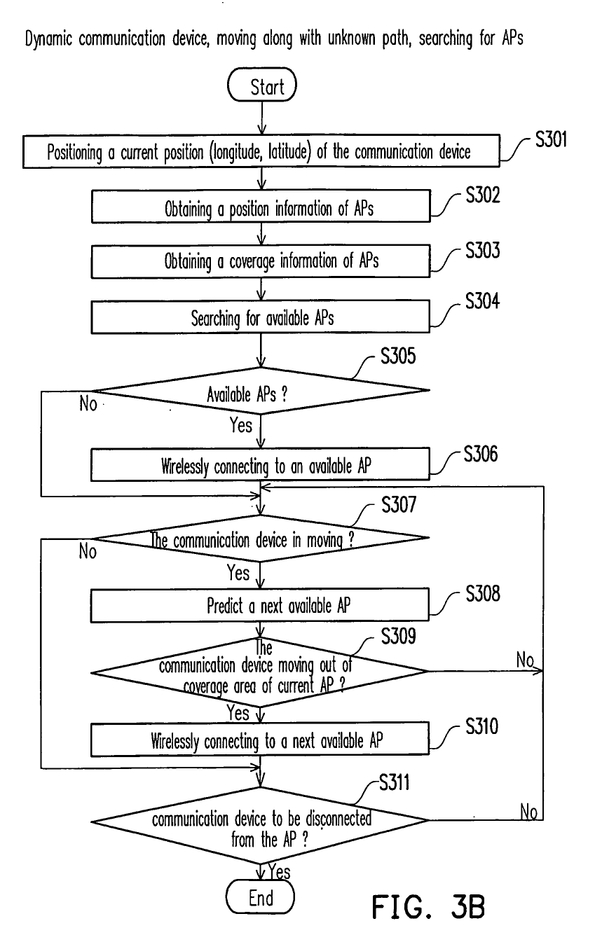

FIG. 3A is a diagram of a wireless network connection management system according to the third embodiment of the present invention, wherein a communication device is in a dynamic state and the moving path thereof is unknown. The wireless network connection management system includes a communication device W30, a positioning system PS3, and a plurality of APs. The communication device W30 may be a WiFi communication device, and the positioning system PS3 may be a GPS system. However, the present invention is not limited thereto.

As shown in FIG. 3A, nine APs AP31˜AP39 are respectively positioned at positions P31˜P39 and they have respective coverage areas R31˜R39. Number, positions, and coverage of the APs are not intended for limiting the present invention.

First, an AP profile is stored in the communication device W30. The AP profile provides a position information and a coverage information of the APs. The position information of the APs indicates the position of each AP. As shown in FIG. 3A, the positions of the APs AP31˜AP39 are respectively P31˜P39. The coverage information of the APs indicates the area covered by each AP. As shown in FIG. 3A, the coverage of the APs AP31˜AP39 is respectively R31˜R39.

Alternatively, in the present embodiment, an AP position profile and an AP coverage profile may be stored in the communication device W30. The AP position profile provides the position information of the APs, namely, the AP position profile indicates that the APs AP31˜AP39 are respectively positioned at the positions P31˜P39. The AP coverage profile provides the coverage information of the APs, namely, the AP coverage profile indicates that the APs AP31˜AP39 respectively cover the areas R31˜R39.

Referring to FIG. 3A, when the communication device W30 is in a dynamic state and the moving path thereof is unknown, the communication device W30 is positioned by a GPS positioning system, so as to obtain a current position S30 (i.e. the longitude and latitude of the position S30) of the communication device W30. Next, the communication device W30 obtains the position information of the APs around the position S30 (i.e. the positions P31˜P39 of the APs AP31˜AP39) according to the AP profile or the AP position profile. Besides, the communication device W30 also obtains the coverage information of the APs around the position S30 (i.e. the coverage R31˜R39 of the APs AP31˜AP39) according to the AP profile or the AP coverage profile.

Thereafter, the communication device W30 searches for all the available APs among the APs AP31˜AP39 according to the position information, the coverage information, and the current position S30. As shown in FIG. 3A, the communication device W30 is within only the coverage of AP31 when it is at its current position S30. Thus, the communication device W30 finds out that the available AP is AP31. As a result, the communication device W30 is wirelessly connected to AP31 at its current position S30 so as to access network through AP31.

After that, whether the communication device W30 obviously moves is determined. If the communication device W30 does not move, it keeps accessing the network through AP31. If the communication device W30 is moving, it predicts a next available AP according to the position information, the coverage information, and the moving direction thereof. As shown in FIG. 3A, the next available AP is predicted to be AP33.

The communication device W30 is wirelessly connected to the predicted next available AP automatically, quickly, and seamlessly if it moves out of the coverage of the currently connected AP. As shown in FIG. 3A, the communication device W30 moves out of the coverage R31 of AP31 when it moves to the position T31. In this case, the communication device W30 is wirelessly connected to AP33 automatically, quickly, and seamlessly.

Because the communication device W30 keeps moving, the next available AP can be predicted to be AP35 according to the position information, the coverage information, and the moving direction of the communication device W30. The communication device W30 is out of the coverage R33 of AP33 once it moves to the position T32, and in this case, the communication device W30 is wirelessly connected to AP35 automatically, quickly, and seamlessly.

Similarly, because the communication device W30 keeps moving, the next available AP can be predicted to be AP37 according to the position information, the coverage information, and the moving direction of the communication device W30. The communication device W30 is out of the coverage R35 of AP35 once it moves to the position T33, and in this case the communication device W30 is wirelessly connected to AP37 automatically, quickly, and seamlessly.

As described above, the communication device W30 can connect to a next available AP automatically, quickly, and seamlessly and accordingly can access network when it continues to move. The communication device W30 is disconnected from the AP if it needs not to access network anymore.

It should be noted that the communication device is wirelessly connected to an available AP directly if no password authentication is required. On the other hand, if password authentication is required, an authentication password profile can be stored in advance into the communication device, and the authentication between the communication device and the AP can then be carried out according to the authentication password profile. The communication device is wirelessly connected to an AP if it passes the authentication of the AP.

Additionally, the communication device cannot access network if there is no available AP within a particular section of the path when the communication device is moving. The communication device can only be wirelessly connected to an available AP so as to access network through this available AP when it moves into an area covered by at least one available AP.

FIG. 3B is a flowchart illustrating a wireless network connection management method according to the third embodiment of the present invention. As shown in FIG. 3B, the wireless network connection management method includes following steps. In step S301, the communication device is positioned, namely, the longitude and latitude of the communication device are obtained, by the positioning system. In step S302, the communication device obtains the position information of the APs in the vicinity thereof according to the AP profile or the AP position profile. In step S303, the communication device obtains the coverage information of the APs in the vicinity thereof according to the AP profile the AP coverage profile. In step S304, the communication device searches for all the available APs according to the position information, the coverage information, and the current position thereof. In step S305, the communication device determines whether there is any available AP. If available APs are found, the process proceeds to step S306, otherwise the process proceeds to step S307. In step S306, the communication device is wirelessly connected to the available AP found in step S305. In step S307, whether the communication device obviously moves is determined. If so, the process proceeds to step S308, otherwise, the process proceeds to step S311. In step S308, the communication device predicts a next available AP according to the position information, the coverage information, and the moving direction of the communication device. In step S309, whether the communication device moves out of the coverage of the currently connected AP is determined. If so, the process proceeds to step S310, otherwise the process proceeds to step S307. In step S310, the communication device is wirelessly connected to the next available AP predicted in step S308 automatically, quickly, and seamlessly. In step S311, whether the communication device is to be disconnected from the AP is determined. If the communication device is to be disconnected from the AP, the process is ended, otherwise, the process proceeds to step S307.

According to the third embodiment of the present invention, the communication device is positioned by the positioning system without modification to the wireless network connection system and the existing positioning system, so that the communication device can find available APs without search for APs constantly, and accordingly, the power consumption of the communication device can be reduced. Moreover, the communication device can wirelessly access network constantly by predicting the next available AP, and accordingly the time required for the AP switching can be greatly reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless network connection management method, suitable for a wireless network connection management system having a positioning system, a communication device, and a plurality of wireless access points (WAPs or APs), the wireless network connection management method comprising:
positioning the communication device by the positioning system;
obtaining a position information and a coverage information of the APs, by the communication device;
determining whether there is at least one AP available to the communication device according to the position information and the coverage information; and
wirelessly connecting the communication device to the available AP.

2. The wireless network connection management method according to claim 1, wherein the step of obtaining the position information and the coverage information of the APs, by the communication device comprises:
reading an AP profile stored in the communication device, wherein the AP profile records the position information and the coverage information of the APs.

3. The wireless network connection management method according to claim 1, wherein the step of obtaining the position information and the coverage information of the APs by the communication device comprises:
reading an AP position profile stored in the communication device, wherein the AP position profile records the position information of the APs; and
reading an AP coverage profile stored in the communication device, wherein the AP coverage profile records the coverage information of the APs.

4. The wireless network connection management method according to claim 1, wherein the step of wirelessly connecting the communication device to the available AP comprises:
performing authentication between the communication device and the AP according to an AP authentication password profile.

5. A wireless network connection management method, suitable for a wireless network connection management system having a positioning system, a communication device, and a plurality of APs, the wireless network connection management method comprising:
positioning the communication device which is already in or is going to be in a dynamic state by the positioning system;
obtaining a position information and a coverage information of the APs by the communication device;
planning a path information of the communication device according to a current position and a destination of the communication device;
searching for APs available to the communication device among the APs according to the path information, the position information, and the coverage information;
determining an AP switch position;
wirelessly connecting the communication device to an available AP among the APs; and
allowing the communication device to be wirelessly and automatically connected to another available AP among the APs if the communication device moves close to the AP switch position.

6. The wireless network connection management method according to claim 5, wherein the step of obtaining the position information and the coverage information of the APs by the communication device comprises:
reading an AP profile stored in the communication device, wherein the AP profile records the position information and the coverage information of the APs.

7. The wireless network connection management method according to claim 5, wherein the step of obtaining the position information and the coverage information of the APs by the communication device comprises:
reading a AP position profile stored in the communication device, wherein the AP position profile records the position information of the APs; and
reading an AP coverage profile stored in the communication device, wherein the AP coverage profile records the coverage information of the APs.

8. The wireless network connection management method according to claim 5, wherein the step of wirelessly connecting the communication device to the available AP among the APs comprises:
performing authentication between the communication device and the AP according to an AP authentication password profile.

9. A wireless network connection management method, suitable for a wireless network connection management system having a positioning system, a communication device, and a plurality of APs, the wireless network connection management method comprising:
positioning the communication device by the positioning system;
obtaining a position information and a coverage information of the APs by the communication device;
searching for all the APs available to the communication device among the APs according to the position information and the coverage information;
wirelessly connecting the communication device to an available AP among the APs;
determining whether the communication device is moving;
predicting a next available AP if the communication device is moving; and
allowing the communication device to be wirelessly and automatically connected to the predicted next available AP among the APs when the communication device moves out of a coverage of the currently connected AP.

10. The wireless network connection management method according to claim 9, wherein the step of obtaining the position information and the coverage information of the APs by the communication device comprises:
reading an AP profile stored in the communication device, wherein the AP profile records the position information and the coverage information of the APs.

11. The wireless network connection management method according to claim 9, wherein the step of obtaining the position information and the coverage information of the APs by the communication device comprises:
reading an AP position profile stored in the communication device, wherein the AP position profile records the position information of the APs; and
reading an AP coverage profile stored in the communication device, wherein the AP coverage profile records the coverage information of the APs.

12. A wireless network connection management system, comprising:
a communication device;
a positioning system, for positioning the communication device;
a plurality of APs, wherein the communication device wirelessly accesses a network through the APs and the communication device obtains a position information and a coverage information of the APs;
wherein,
when the communication device is in a static state, the communication device determines whether there is at least one available AP according to the position information and the coverage information; and the communication device is wirelessly connected to the available AP;
when the communication device is already in or is going to be in a dynamic state moving along a known path, the communication device plans a path information according to a current position and a destination of the communication device; the communication device searches for available APs among the APs according to the path information, the position information, and the coverage information; the communication device determines an AP switch position; the communication device is wirelessly connected to an available AP among the APs; and the communication device is wirelessly and automatically connected to another available AP among the APs if the communication device moves to the AP switch position; and
when the communication device is already in or is going to be in a dynamic state moving along an unknown path, the communication device is wirelessly connected to an available AP among the APs; whether the communication device is moving is determined; the communication device predicts a next available AP if the communication device is moving; and the communication device is wirelessly and automatically connected to the predicted next available AP among the APs if the communication device moves out of a coverage of the currently connected AP.

13. The wireless network connection management system according to claim 12, wherein the communication device reads an AP profile, and the AP profile records the position information and the coverage information of the APs.

14. The wireless network connection management system according to claim 12, wherein,
the communication device reads an AP position profile, and the AP position profile records the position information of the APs; and
the communication device reads an AP coverage profile, and the AP coverage profile records the coverage information of the APs.

15. The wireless network connection management system according to claim 12, wherein the communication device performs authentication between the communication device and the AP according to an AP authentication password profile.
